(19) United States
(12) Patent Application Publication
(10) Pub. No.: US 2024/0400248 A1
(43) Pub. Date: Dec. 5, 2024

(54) PACKAGE LABELING DEVICE AND METHOD

(71) Applicant: UltraSource LLC, Kansas City, MO (US)

(72) Inventors: Jess Colby Ross, II, Kansas City, MO (US); James R. Harte, Shawnee, KS (US)

(73) Assignee: UltraSource LLC, Kansas City, MO (US)

(21) Appl. No.: 18/327,524

(22) Filed: Jun. 1, 2023

(51) Int. Cl. B65C 9/42; B65B 57/10; B65B 61/26; B65C 9/02

(52) U.S. Cl. CPC B65C 9/42; B65B 57/10; B65B 61/26; B65C 9/02

(57) ABSTRACT

A method of labeling product packages on a thermoforming packaging machine is provided to prevent the unnecessary dispensing of labels onto unfilled, improperly filled and absent product packages. Crosswise rows of product packages are moved in a downstream transport direction on the thermoforming machine using alternating dwell and advancing intervals. A labeling device mounted on the thermoforming packaging machine moves back and forth between a downstream position and an upstream position and applies to the product packages while the labeling device is moving from the downstream position to the upstream position and while the labeling device is moving from the upstream position to the downstream position. One or more sensors positioned on the thermoforming packaging machine upstream from the upstream position of the labeling device identify the presence of any unfilled, improperly filled or absent product packages in the crosswise rows of product packages before they reach the upstream position of the labeling device to prevent the labeling device from applying labels to any such product packages. A thermoforming packaging machine is also provided on which the method may be performed.

### BACKGROUND

The present disclosure relates generally to thermoforming packaging machines, such as horizontal form, fill and seal packaging machines, and more particularly, to an apparatus and method for detecting unfilled or otherwise improperly filled packages during operation of the packaging machines on a packaging system to prevent the dispensing of labels on the empty or absent packages.

Thermoforming packaging machines such as horizontal form, fill and seal packaging machines are used in the packaging industry to package a wide variety of products in a generally automated assembly-line process. In such machines, continuous rolls of plastic film are used to form the top and bottom of the product packaging in a stepwise, indexing fashion. The products are typically placed on the bottom film after it has been suitably formed to create individual receptacles for the products. The top film is then applied onto the bottom film and the top and bottom films are heat sealed together around the perimeter of the products to create the individual product packages. Labels with product information and other indica are applied to the product packages using an automated labeling device. The individual product packages may then be separated from each other in a cutting operation.

These thermoforming packaging machines typically perform the forming, filling, and sealing operations at separate stations while the top and bottom webs are stationary. The packaging machine then indexes to advance the rows of product packages in a downstream direction to the next station, if any, and the indexing advancement is stopped and the forming, filling, and sealing operations are repeated. To increase the operational speed of the thermoforming packaging machine, multiple crosswise rows of product receptacles, rather than a single row of product receptacles, may be simultaneously formed at a forming station during stoppage of the top and bottom webs. During the next indexing advancement of the top and bottom webs, these multiple rows of product receptacles are advanced to a filling station where they are filled with product and are then advanced to a sealing station to create the individual product packages during the subsequent indexing advancement.

Automated labeling machines devices are typically designed to place labels on the product packages in a crosswise direction to the downstream transport direction of the product packages. Some known labeling devices have been mounted for movement on the packaging machine so that the labeling device is able to move upstream and apply labels to multiple stationary rows of product packages one row at a time before the thermoforming packaging machine indexes and advances the multiple rows in a downstream direction to the next station. One such type of movable labeling device then re-homes itself from the upstream position to its original downstream position in sync with the indexing movement of the thermoforming packaging machine and then resumes applying labels to successive multiple rows of stationary product packages as it moves in the upstream direction.

Another such type of movable labeling device can operate at higher speeds by not re-homing itself to its original downstream position during indexing movement of the thermoforming packaging machine. Instead, the labeling device remains stationary at the upstream position until the indexing movement has stopped and then applies labels to a successive set of multiple rows of stationary product packages in the downstream direction. During the next indexing movement, the labeling device remains stationary at the downstream location and then applies labels in the upstream direction during the next indexing stoppage, with the sequence of movements repeating during successive indexing movements/stoppages.

Some types of known automated labeling devices that are mounted for movement on the thermoforming packaging machine may include multiple sensors that are mounted on the labeling device and face in the upstream direction. These sensors are used to detect absent or empty product packages within the next row of advancing product packages so that a label is not applied on the absent or empty product package. Because the sensors face in the upstream direction, the labeling device cannot be used to detect absent or empty product packages when it is moving from an upstream position to a downstream position. Thus, the labeling device must re-home itself from the upstream position to the downstream position each time the thermoforming packaging machine indexes and advances the top and bottom webs in the downstream or transport direction. As a result, when the upstream facing sensors are used, operational speed is reduced because the labeling device is only able to apply labels to the product packages while it is moving in the upstream direction.

Accordingly, there is a need for a thermoforming packing machine having an automated labeling device that is able to apply labels and avoid unnecessarily dispensing labels on absent or empty packages while moving in both an upstream direction and in a downstream direction so that higher labeling speeds may be achieved.

### BRIEF DESCRIPTION

The following brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, the disclosure is directed to a method of labeling product packages on a thermoforming packaging machine, comprising the steps of: moving crosswise rows of product packages in a downstream transport direction on the thermoforming machine using alternating dwell and advancing intervals; moving a labeling device mounted on the thermoforming packaging machine back and forth between a downstream position and an upstream position; applying labels from the labeling device to the product packages while the labeling device is moving from the downstream position to the upstream position and while the labeling device is moving from the upstream position to the downstream position; using one or more sensors positioned on the thermoforming packaging machine upstream from the upstream position of the labeling device to identify the presence of any unfilled product packages in the crosswise rows of product packages before they reach the upstream position of the labeling device; and preventing the labeling device from applying labels to any unfilled product packages in the crosswise rows of product packages detected by the one or more sensors.

In another aspect, the disclosure is directed to a thermoforming packaging machine comprising: a frame; a forming station for forming a web of product receptacles using a bottom film; a product filling station located downstream in a transport direction from the forming station for placing a product in the product receptacles; a sealing station located downstream in the transport direction from the product filling station for securing a top film to the bottom film to form product packages; a labeling station located downstream from the sealing station in the transport direction and comprising a labeling device that is mounted on the frame for back-and-forth movement in the transport direction and opposite from the transport direction between a downstream position and an upstream position and is operable to apply labels to the product packages while moving in both the transport direction and a direction opposite from the transport direction; and one or more sensors mounted on the frame upstream from the upstream position and operable to identify the presence of any product packages that are unfilled with product and operable to communicate with the labeling device to prevent the labeling device from apply labels to the unfilled product packages while the labeling device is moving in both the transport direction and the direction opposite from the transport direction.

In a further aspect, the disclosure is directed to a thermoforming packaging machine comprising: a frame; a forming station for forming a web of product receptacles using a bottom film; a product filling station located downstream in a transport direction from the forming station for placing a product in the product receptacles; a sealing station located downstream in the transport direction from the product filling station for securing a top film to the bottom film to form product packages; a transport mechanism mounted to the frame at opposite sides of the thermoforming packing machine for mechanically grasping side edges of the top and bottom films and moving them in the transport direction in alternating dwell and advancing intervals; a labeling station located downstream from the sealing station in the transport direction and comprising a labeling device that is mounted on the frame for back-and-forth movement in the transport direction and opposite from the transport direction between a downstream position and an upstream position and is operable to apply labels to the product packages while moving in both the transport direction and a direction opposite from the transport direction, wherein the labeling device is operable to apply the labels to the product packages while the transport mechanism is in the dwell intervals, wherein the labeling device is operable to apply the labels on product packages in multiple crosswise rows of the product packages during each dwell interval; and one or more sensors mounted on the frame upstream from the upstream position and operable to identify the presence of any product packages that are unfilled or improperly filled with product and operable to communicate with the labeling device to prevent the labeling device from apply labels to the unfilled or improperly filled product packages while the labeling device is moving in both the transport direction and the direction opposite from the transport direction.

### BRIEF DESCRIPTION OF THE DRAWING FIGURES

The present disclosure is described in detail below with reference to the attached drawing figures, wherein:

FIG. 1 is an upper front perspective view of a thermoforming packaging machine constructed in accordance with an embodiment of the present disclosure;

FIG. 2 is an upper rear perspective view of the thermoforming packaging machine shown in FIG. 1;

FIG. 3 is another upper front perspective view of the thermoforming packaging machine shown in FIGS. 1 and 2, but with portions removed to illustrate features of the disclosure;

FIG. 4 is a fragmentary upper front perspective view of the thermoforming packaging machine similar to FIG. 3, but enlarged to show more details of a labeling device;

FIG. 5 is a fragmentary upper front perspective view of the thermoforming packaging machine similar to FIG. 4, but enlarged to show more details of a sensor assembly positioned upstream of the labeling device;

FIG. 6 is a fragmentary front perspective view of the thermoforming packaging machine similar to the view shown in FIG. 4 but taken from a different perspective to show other features of the labeling device;

FIG. 7 is a rear perspective view of the labeling device;

FIG. 8 is a bottom perspective view of the labeling device; and

FIG. 9 is a rear perspective view of a fragmental portion of the labeling device showing a belt drive.

The drawing figures do not limit the present disclosure to the specific embodiments disclosed and described herein.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

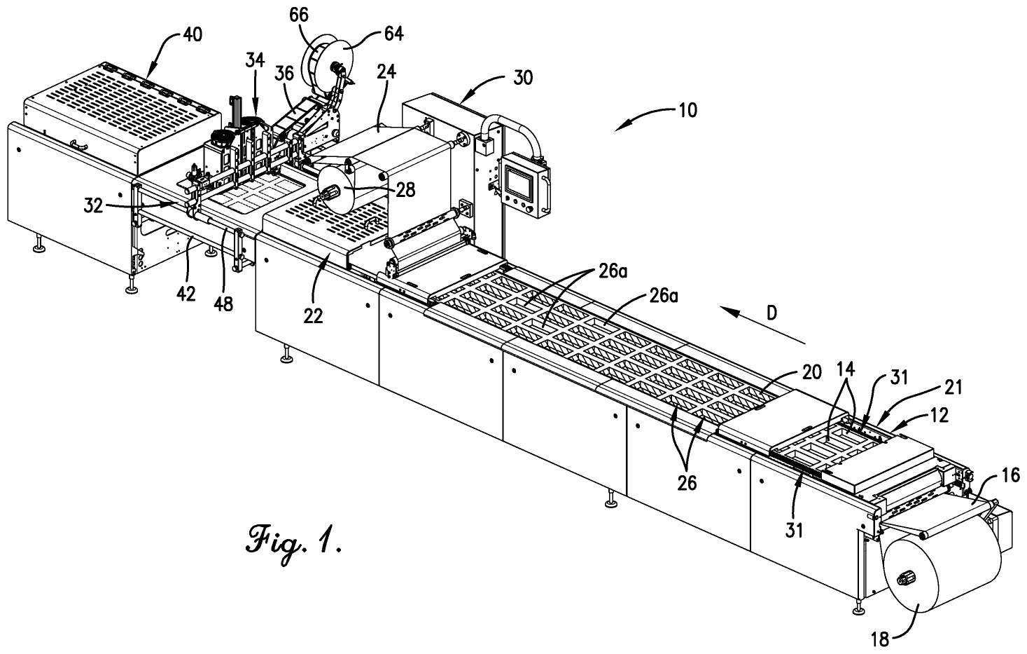

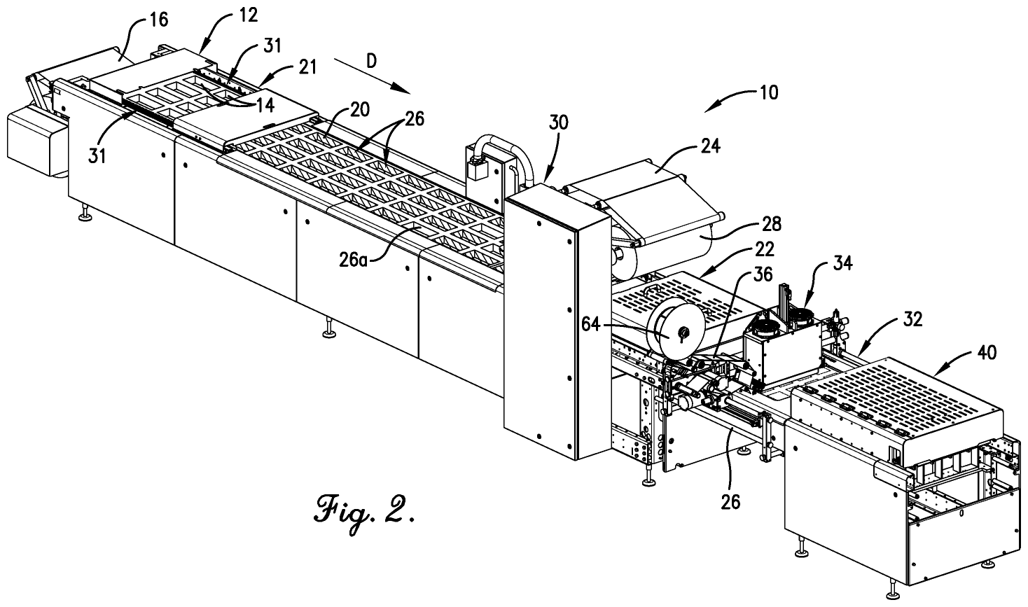

Turning now to the drawings in greater detail, and initially to FIGS. 1-3, a thermoforming packaging machine in the form of a horizontal form-fill-seal machine is represented broadly by the numeral 10 and comprises a forming station 12 where crosswise rows of side-by-side product receptacles 14 are formed in a bottom film 16. The bottom film 16 is dispensed in a step-wise indexing fashion from a film supply roll 18 that may be positioned at an upstream end of the thermoforming packaging machine 10. A product 20, such as a food item or other article, may be placed in the product receptacles 14 by hand or using a suitable dispenser (not shown) at a product filling station 21 located downstream in a transport direction D from the forming station 12.

The thermoforming packaging machine 10 includes a sealing station 22 that is located downstream in the transport direction D from the product filling station 21. Following dispensing of the product 20 into the product receptacles 14 at the product filling station 21, a top film 24 is secured to the bottom film 16 at the sealing station 22 using heat, adhesive, or other means to form a number of product packages 26 that are joined together as a web. In one embodiment, the top film 24 may be secured to the bottom film 16 along a peripheral margin of each of the product-filled, product receptacles 14. The product packages 24 may be arrayed side-by-side in crosswise rows and end-to-end in a plurality of lanes that extend in the downstream or transport direction D.

The top film 24 is dispensed from a supply roll 28 in the same step-wise indexing fashion as the bottom film 16. The supply roll 28 may be positioned at an overhead portion 30 of the thermoforming packaging machine 10 and the top film 24 may be routed so that it feeds vertically downward to an upstream end of the sealing station 22 prior to joinder with the horizontally-advancing bottom film 16. Various types of transport mechanisms may be used for the bottom and top films 16 and 24, such as gripping chains 31 that extend along the length and at opposite sides of the thermoforming packaging machine 10 and mechanically grasp the side edges of the bottom and top films 16 and 24 and move them in the downstream transport direction D.

The thermoforming packaging machine 10 also includes a labeling station 32 where a labeling device 34 applies labels 36 from a supply roll 38 to a surface of the formed product packages 26, as will be described in greater detail below, and may include a cutting station 40 where individual or groups of the product packages 26 may be separated from other individual or groups of product packages 26 for subsequent packaging and transport.

In general, the thermoforming packaging machine 10 may be operated to move the crosswise rows of product packages 26 in the downstream or transport direction D using alternating dwell and advancing intervals that may be of the same duration or different durations. In one embodiment, during each dwell interval, a preselected number of the crosswise rows of product receptacles 14 are formed, the product 20 is loaded into a preselected number of another group of one or more of the crosswise rows of product receptacles 14, and the labeling device 34 applies the labels 36 a preselected number of the crosswise rows of the product packages 26. The preselected number of the crosswise rows may be the same or different for each of these steps. In one example, the preselected number is the same for each of the steps and the preselected number is 2. In other examples, the preselected number is the same for each of the steps and the preselected number is 3, any number from 4 to 10, any number from 11 to 20, or any number from 21 to 100 or greater.

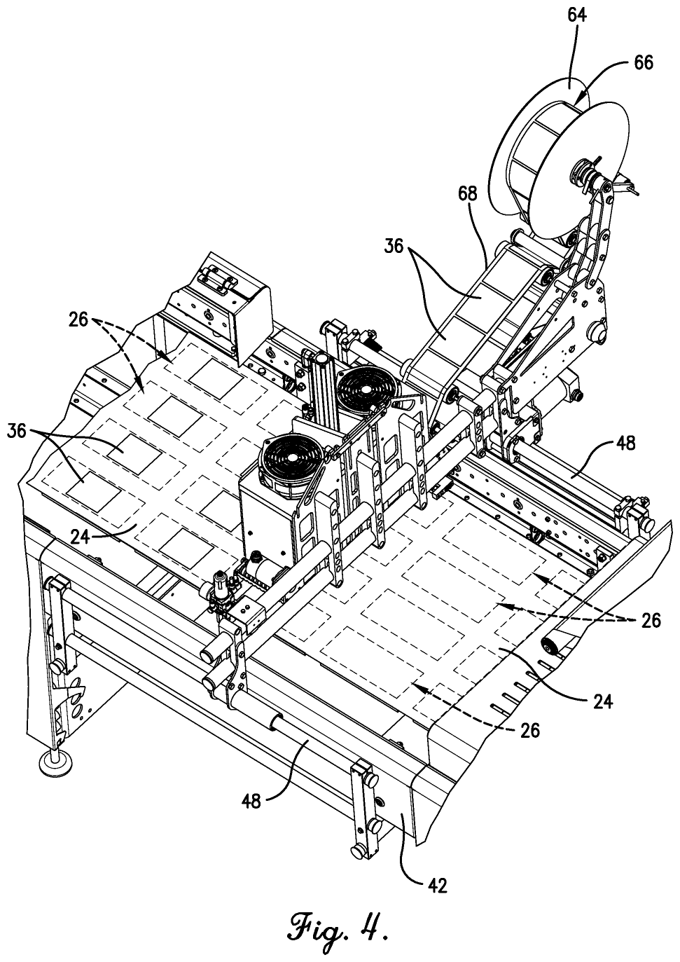

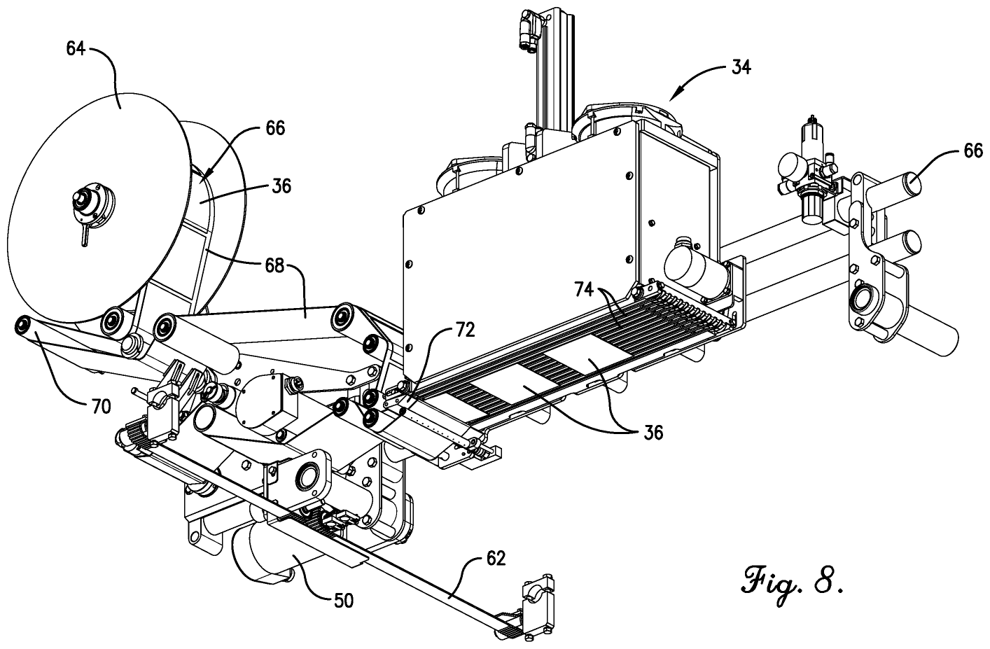

Turning additionally to FIGS. 4-9, the labeling device 34 may be mounted to a frame 42 of the thermoforming packaging machine 10 and is moveable back and forth between an upstream position and a spaced apart downstream position. The upstream and downstream positions may both be located downstream from the sealing station 22 and upstream from the cutting station 40 if present. The labeling device 34 is able to apply the labels 36 to the product packages 26 as the labeling device 34 moves from the downstream position to the upstream position and also while it moves from the upstream position to the downstream position, thus allowing for an increase in labeling speeds in comparison to a labeling device that only applies the labels 36 while moving in the upstream direction. The labels 36 may be applied to the bottom film 16 or to the top film 24 of the product packages 26 and may display various indicia, such as a company logo, package contents, package ingredients and/or other desired information.

In one embodiment, the labeling device 34 operates during one the dwell intervals to apply the labels 36 to the product packages 26 in one of the crosswise rows of product packages 26 before advancing and applying the labels 36 to the next crosswise row of product packages 26 in a repeating pattern. For example, the labeling device 34 may be operable while in a stationary position at the downstream position to apply the labels 36 to the crosswise row of product packages 26 that are located at the downstream position. The labeling device 34 may then move in the upstream direction to the next crosswise row of product packages 26 where it momentarily stops to apply the labels 36 to that crosswise row of the product packages 26. This process is repeated until the labeling device 34 reaches the upstream position, at which point the labeling device 34 remains stationary as the product packages 26 are moved downstream in the transport direction D during the advancing interval.

During the next dwell interval, the labeling device 34 may repeat the described process of applying the labels 36 to successive crosswise rows of product packages 26 while moving in the downstream transport direction D until it reaches the downstream position. The described back and forth process of applying the labels 36 may then be repeated until there are no more product packages 26 to be labeled. In one implementation, the labeling device 34 may be operated to simultaneously apply the labels 34 to each of the properly filled product packages 26 within the crosswise row of product packages 26.

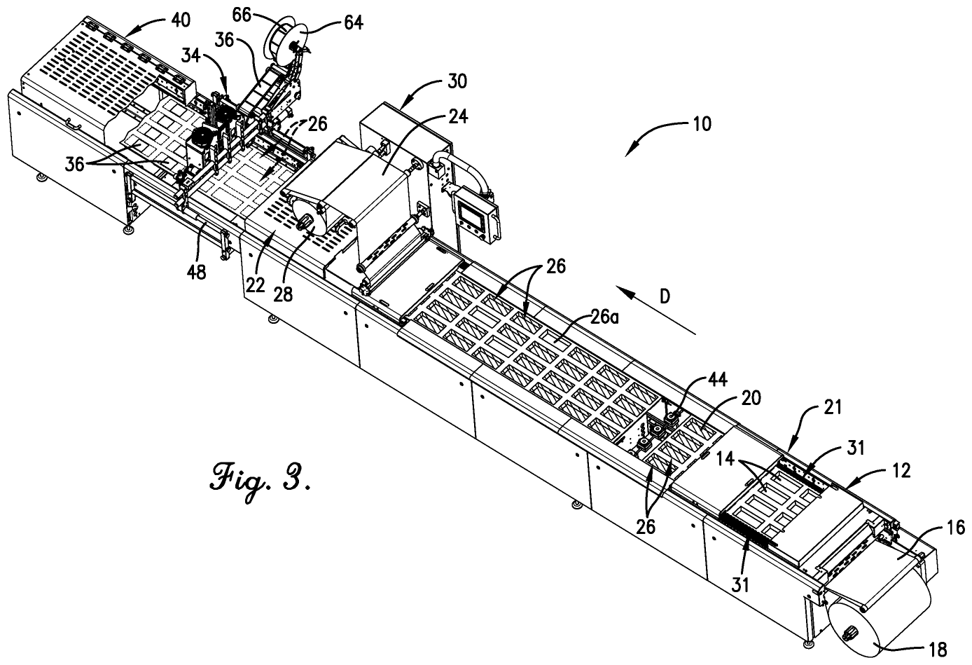

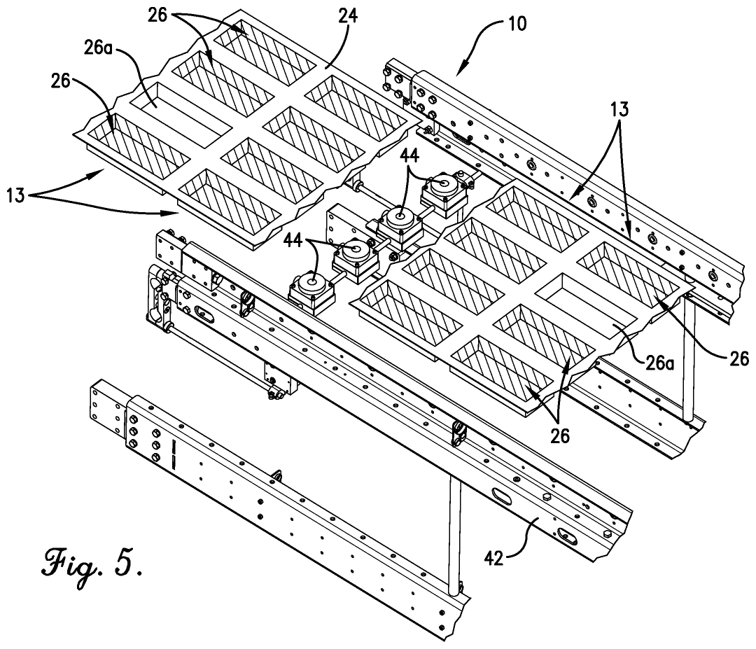

As can be seen in FIGS. 3 and 5, one or more sensors 44 are mounted upstream from the labeling station 32, and from the upstream position of the back-and-forth movement of the labeling device 34, to identify the presence of any unfilled or improperly filled product packages 26a before they reach the upstream position of the labeling device 34. Improperly filled product packages 26a include those that are underfilled or overfilled in relation to the desired quantity of product 20 in the product packages 26. The sensors 44 may also be used to detect the absence of one or more of the product packages 26.

The one or more sensors 44 may be mounted to the frame 42 of the thermoforming packaging machine 10 and positioned below or above, and closely spaced from or in contact with, the product packages 26. In one embodiment, the number of sensors 44 corresponds to the number of product packages 26 in each crosswise row of product packages 26, with each sensor 44 positioned in alignment with one of the lanes of the product packages 26. The sensors 44 may be sideways adjustable so that the number and positioning of the sensors 44 may be adjusted to correspond to the number of lanes of the product packages 26. The sensors 44 may comprise various types of sensors selected for determining whether the product packages 26 are unfilled or improperly filled with the product 20. In some instances, the type of sensors 44 may be selected based on the type of product 20 in the product packages 26. In various embodiments, and without limitation, the sensors 44 may be proximity sensors, such as capacitive sensors or inductive sensors, optical sensors, and/or cameras.

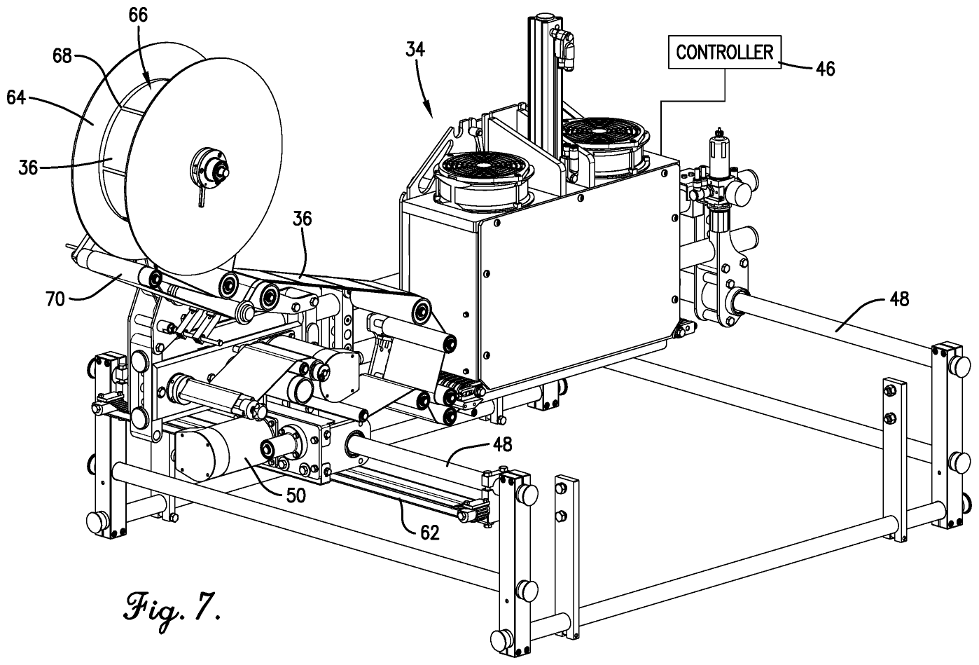

The sensors 44 are in communication with and provide information, such as package identification data, regarding the filled status of the product packages 26 to other components of the thermoforming packaging machine 10. In one embodiment, the sensors 44 are in communication with and provide package identification data to a controller 46 (FIG. 7) that may be part of or otherwise in communication with the labeling device 34. For example, the controller 46 may be one that is dedicated to controlling the operation of the labeling device 34. In another example, the controller 46 may be one that controls additional aspects, or all, of the operation of the thermoforming packaging machine 10. The sensors 44 may be configured for wired or wireless communication with the controller 46 using standard communication protocols, including, but not limited to, Ethernet/IP, Modbus TCP, and RS-232.

By providing the information to the labeling device 34, the one or more sensors 44 may be operable to prevent the labeling device 34 from applying the labels 36 to any unfilled or improperly filled or absent product packages 26a in the crosswise rows of product packages 26 while applying the labels 36 to properly filled product packages 26 during the back-and-forth movement of the labeling device 34 as it moves between the downstream and upstream positions in the transport direction D and a direction that is opposite from the transport direction D. In one embodiment, the labeling device 34 moves from the downstream position to the upstream position and applies the labels 34 to the product packages 26 in one group of crosswise rows of product packages 26 during one dwell interval and then moves from the upstream position to the downstream position and applies the labels 34 to the product packages 26 in the next group of crosswise rows of product packages 26 during the next dwell interval, in a repeating or serial fashion.

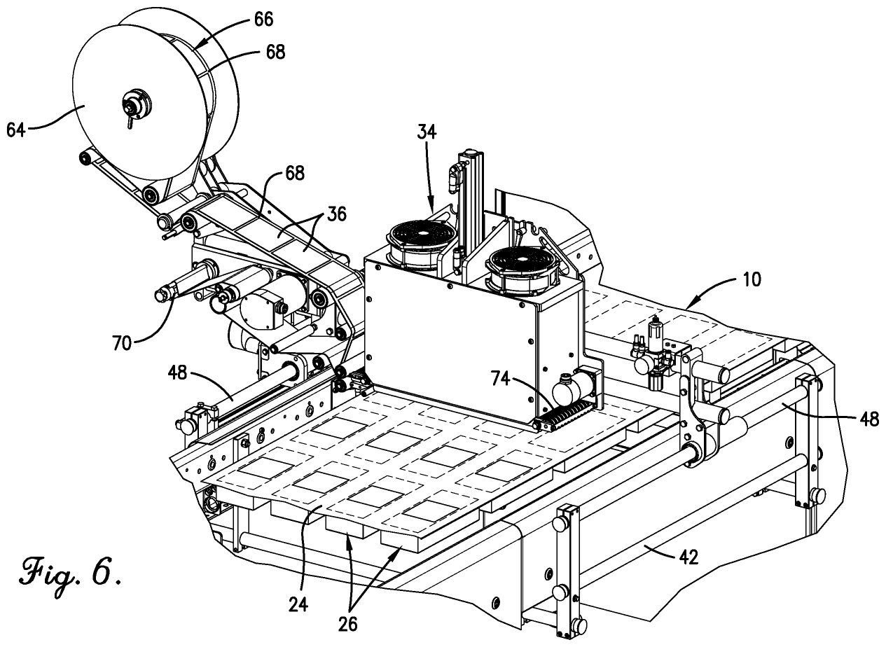

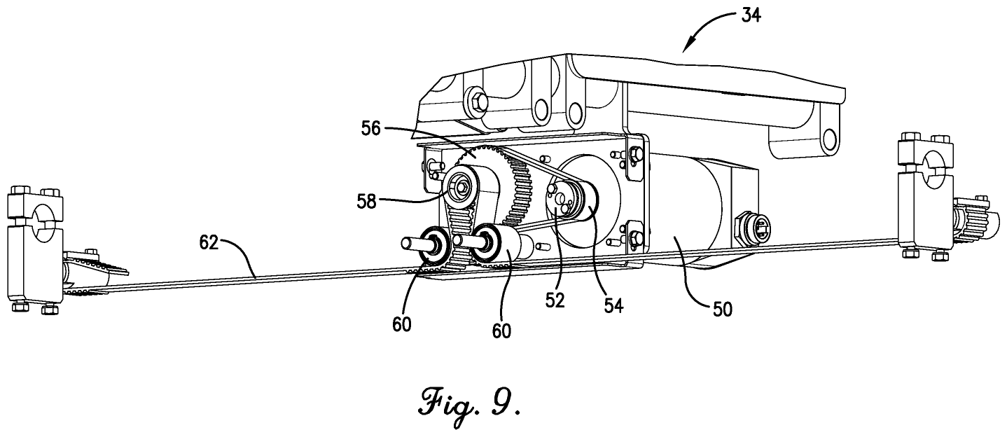

Turning now more closely to FIGS. 6-9, the labeling device 34 may be mounted on tubular rails 48 secured to the frame 42 of the thermoforming packaging machine 10 for movement between the downstream and upstream positions. As can best be seen in FIG. 9, the labeling device 34 includes a drive motor 50 may be used to cause the back-and-forth movement of the labeling device between the downstream and upstream positions. In one embodiment, a drive shaft 52 of the drive motor 50 may be coupled by a drive belt 54 to a toothed gear 56. The toothed gear 56 may also carries a smaller toothed gear 58 that, with the assistance of guide rollers 60, engages a stationary toothed belt 62 that extends longitudinally and is secured to the frame 42 of the thermoforming packaging machine 10. As the drive motor 50 reversible drives rotation of the drive shaft 52, the drive belt 54 is turned and causes rotation of the toothed gear 56 and the smaller toothed gear 58. Reversing rotational movement of the smaller toothed gear 58 causes the labeling device 34 to move along the stationary toothed belt 62 in the back-and-forth movement between the downstream and upstream positions.

Returning to FIGS. 6-9 more generally, the labeling device 34 may include a spool 64 on which a label roll 66 is positioned. The label roll 66 comprises the individual labels 36 that are removably affixed to a backing web 68. The labels 36 and the backing web 68 are routed around a series of guide rollers 70 before encountering a label peeler blade 72 that separates the labels 36 from the backing web 68 and causes them to be delivered onto a vacuum assisted label conveyer 74. The label conveyer 74 extends in a crosswise direction that is parallel with the crosswise rows of the product packages 26. The label conveyer 74 carries a number of the labels 36 that normally corresponds to the preselected number of product packages 26 in each of the crosswise rows of product packages 26 and places them in registry with the product packages 26. The labels 36 on the label conveyor 74 may then be applied to the adjacent top film 24 of the product packages 26 as shown in the illustrated embodiment or to the adjacent bottom film 16 of the product packages 26. Application of the labels 36 to the product packages 26 may be achieved by causing downward movement of the label conveyor 74 to bring an adhesive surface of the labels 36 into contact with the top film 24 of the product packages 26. If the labels 36 are to be applied to the bottom film 16 of the product packages 26, the labeling device 34 is mounted below the product packages 26 and the label conveyor 74 is caused to move upwardly to bring the adhesive surface of the labels 36 into contact with the bottom film 16.

When the one or more sensors 44 detect one or more unfilled, improperly filled, or missing product packages 26a within a crosswise row of product packages 26, the labels 36 are delivered to the label conveyor 74 in a manner to align with only those product packages 26 that are properly filled with product 20 when the labeling operation for that crosswise row of product packages 26 occurs. Because the one or more sensors 44 are positioned upstream from the upstream location of the back-and-forth movement of the labeling device 34, the sensors 44 are able to prevent the application of the labels 36 to unfilled, improperly filled, or missing product packages 26a while the labeling device 34 is moving in the upstream direction and while the labeling device 34 is moving in the downstream direction. This process allows high labeling speeds to be achieved while avoiding the wasteful application of the labels 36 to the unfilled, improperly filled, or missing product packages 26a.

Not applying labels 36 to unfilled, improperly filled, or missing product packages 26a may have other benefits in addition to reducing waste. Because the labeling device 34 exerts pressure against the labels 36 to secure them onto the product packages 26, the labels 36 are less likely to adhere to unfilled, improperly filled, or missing product packages 26a in which the application surface is in a different plane than the properly filled packages 26. As a result, the labels 36 may fall off the unfilled, improperly filled, or missing product packages 26a and create maintenance problems such as jamming up various mechanisms of the labeling device 34. Not applying the labels 36 to the unfilled, improperly filled, or missing product packages 26a may reduce the opportunity for the labels 36 to create these additional maintenance issues. The absence of the labels 36 on the unfilled, improperly filled, or missing product packages 26a also allows the unfilled, improperly filled, or missing product packages 26a to be more readily identified so that they may be segregated in a manual or automated manner from the properly filled product packages 26 prior to packaging and shipment.

The thermoforming packaging machine 20 may include a variety of control devices, such as an industrial C-programmable controller. The control devices may be programmed with one or more computer programs to control operation of the thermoforming packaging machine 20 as described herein. The computer program may comprise an ordered listing of executable instructions for implementing logical functions in the control devices. The computer program can be embodied in any computer-readable medium for use by or in connection with an instruction execution system, apparatus, or device. Such as a computer-based system, processor-containing system, or other system that can fetch the instructions from the instruction execution system, apparatus, or device, and execute the instructions. In the context of this application, a “computer-readable medium’ can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), an optical fiber, etc.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present disclosure may include a variety of combinations and/or integrations of the embodiments described herein.

The disclosure described above is to be used as illustration only and should not be utilized in a limiting sense in interpreting the scope of the present disclosure. Modifications to the exemplary embodiments, as hereinabove set forth, may be made by those skilled in the art without departing from the spirit of the present disclosure.

The inventors hereby state their intent to rely on the Doctrine of Equivalents to determine and assess the reasonably fair scope of the present disclosure as pertains to any apparatus not materially departing from but outside the literal scope of the disclosure as set forth in the following claims.

1. A method of labeling product packages on a thermoforming packaging machine, said method comprising the steps of:
moving crosswise rows of product packages in a downstream transport direction on the thermoforming machine using alternating dwell and advancing intervals;
moving a labeling device mounted on the thermoforming packaging machine back and forth between a downstream position and an upstream position;
applying labels from the labeling device to the product packages while the labeling device is moving from the downstream position to the upstream position and while the labeling device is moving from the upstream position to the downstream position;
using one or more sensors positioned on the thermoforming packaging machine upstream from the upstream position of the labeling device to identify the presence of any unfilled product packages in the crosswise rows of product packages before they reach the upstream position of the labeling device; and
preventing the labeling device from applying labels to any unfilled product packages in the crosswise rows of product packages detected by the one or more sensors.

2. The method of claim 1, wherein the labeling device applies the labels to the product packages while the crosswise rows of product packages are in the dwell interval.

3. The method of claim 2, in which the labeling device applies labels to the product packages in a preselected number of the crosswise rows of product packages during each dwell interval and the one or more sensors are positioned upstream from the upstream position of the labeling device a sufficient distance to identify the presence of any unfilled product packages in each of the preselected number of the crosswise rows of product packages before they reach the upstream position of the labeling device.

4. The method of claim 3, in which the preselected number of the crosswise rows of product packages is 2.

5. The method of claim 3, in which the preselected number of the crosswise rows of product packages is 3.

6. The method of claim 3, in which the preselected number of the crosswise rows of product packages is between 4 and 20.

7. The method of claim 3, wherein each crosswise row of product packages has a predetermined number of product packages and one of the one or more sensors is provided for each of the predetermined number of product packages.

8. The method of claim 3, wherein the one or more sensors are capacitive, inductive, or optical sensors.

9. The method of claim 3, including sending package identification data identifying the presence of any unfilled product packages from the one or more sensors to a controller and then sending control data from the controller to the labeling device to prevent the labeling device from applying labels to any unfilled product packages in the crosswise rows of product packages detected by the one or more sensors.

10. A thermoforming packaging machine comprising:
a frame;
a forming station for forming a web of product receptacles using a bottom film;
a product filling station located downstream in a transport direction from the forming station for placing a product in the product receptacles;
a sealing station located downstream in the transport direction from the product filling station for securing a top film to the bottom film to form product packages;
a labeling station located downstream from the sealing station in the transport direction and comprising a labeling device that is mounted on the frame for back-and-forth movement in the transport direction and opposite from the transport direction between a downstream position and an upstream position and is operable to apply labels to the product packages while moving in both the transport direction and a direction opposite from the transport direction; and
one or more sensors mounted on the frame upstream from the upstream position and operable to identify the presence of any product packages that are unfilled with product and operable to communicate with the labeling device to prevent the labeling device from apply labels to the unfilled product packages while the labeling device is moving in both the transport direction and the direction opposite from the transport direction.

11. The thermoforming packaging machine of claim 10, wherein the one or more sensors are also operable to identify the presence of any product packages that are improperly filled with product and are also operable to communicate with the labeling device to prevent the labeling device from apply labels to the improperly filled product packages while the labeling device is moving in both the transport direction and the direction opposite from the transport direction.

12. The thermoforming packaging machine of claim 11, including a transport mechanism mounted to the frame at opposite sides of the thermoforming packing machine for mechanically grasping side edges of the top and bottom films and moving them in the transport direction.

13. The thermoforming packaging machine of claim 12, wherein the transport mechanism is gripping chains.

14. The thermoforming packaging machine of claim 12, wherein the transport mechanism is operable to move the top and bottom films in the transport direction in alternating dwell and advancing intervals.

15. The thermoforming packaging machine of claim 14, wherein the labeling device is operable to apply the labels to the product packages while the transport mechanism is in the dwell intervals.

16. The thermoforming packaging machine of claim 15, wherein the labeling device is operable to apply the labels on product packages in multiple crosswise rows of the product packages during each dwell interval.

17. The thermoforming packaging machine of claim 16, wherein one of the one or more sensors is provided for each of the product packages within the crosswise rows of the product packages.

18. The thermoforming packaging machine of claim 17, wherein the one or more sensors are capacitive, inductive, or optical sensors.

19. A thermoforming packaging machine comprising:
a frame;
a forming station for forming a web of product receptacles using a bottom film;
a product filling station located downstream in a transport direction from the forming station for placing a product in the product receptacles;
a sealing station located downstream in the transport direction from the product filling station for securing a top film to the bottom film to form product packages;
a transport mechanism mounted to the frame at opposite sides of the thermoforming packing machine for mechanically grasping side edges of the top and bottom films and moving them in the transport direction in alternating dwell and advancing intervals;
a labeling station located downstream from the sealing station in the transport direction and comprising a labeling device that is mounted on the frame for back-and-forth movement in the transport direction and opposite from the transport direction between a downstream position and an upstream position and is operable to apply labels to the product packages while moving in both the transport direction and a direction opposite from the transport direction,
wherein the labeling device is operable to apply the labels to the product packages while the transport mechanism is in the dwell intervals,
wherein the labeling device is operable to apply the labels on product packages in multiple crosswise rows of the product packages during each dwell interval; and
one or more sensors mounted on the frame upstream from the upstream position and operable to identify the presence of any product packages that are unfilled or improperly filled with product and operable to communicate with the labeling device to prevent the labeling device from apply labels to the unfilled or improperly filled product packages while the labeling device is moving in both the transport direction and the direction opposite from the transport direction.

20. The thermoforming packaging machine of claim 19, wherein one of the one or more sensors is provided for each of the product packages within the crosswise rows of the product packages and the one or more sensors are capacitive, inductive, or optical sensors.
